(19) United States
(12) Patent Application Publication
(10) Pub. No.: US 2007/0260535 A1
(43) Pub. Date: Nov. 8, 2007

(54) Real estate development financing

(76) Inventor: S. Christopher Kontogiannis, Denver, CO (US)

Correspondence Address: Paul E Schaafsma;NovusIP, LLC, Suite 221, 521 West Superior Street, Chicago, IL, 60610-3135, US

(21) Appl. No.: 11/416,054

(22) Filed: May 2, 2006

(51) Int. Cl. G06Q 40/00

(52) U.S. Cl. 705/38

(57) ABSTRACT

A real estate development financing process is provided. Initial financing is provided through equity from a real estate developer. The equity financing from the real estate developer is sufficient to provide overhead protection to an insurable portion of the real estate development costs. The equity from the real estate developer is combined with new debt. The new debt is sufficient to cover fees, insurance premiums, and contingent capital. The equity from the real estate developer and the new debt is combined with senior debt. The senior debt sufficient for the costs of the real estate development remaining after the equity from the developer and the new debt. At least a portion of the new debt or the senior debt or both are insured. In one embodiment, the new debt is collateralized with insurance. The new debt can take the form of an insurance product comprising a low cost debt instrument as a substitute for mezzanine financing in real estate development financing. In one embodiment, a real estate development risk index can also be provided.

### FIELD OF THE INVENTION

The present invention relates to real estate development financing.

### BACKGROUND OF THE INVENTION

Current real estate development financing is fragmented, dependent upon the coordination of competing interests, and generally not materially risk considered. An increased conservatism of senior debt providers in the U.S. and global real estate development sector has created a gap between what lenders will provide and what borrowers want from debt sources. Senior debt lenders are reluctant to finance projects at loan to value (value represented by cost) ratios in excess of specific percentages, such as for example 64%. Existing lines of real estate development credit have been reduced. New loans from traditional lenders are harder to obtain. Access to the public capital markets is virtually non-existent for real estate developers, and the current private capital market has been financially challenging for many developers regardless of proven product demand.

Mezzanine finance plays an ever-increasing role as a source of capital for real estate development financing. A hybrid form of capital, mezzanine financing is sandwiched between senior debt and equity on a balance sheet. Structurally, mezzanine financing is subordinated or “junior” in priority of payment to senior debt, but ranks higher than common stock or equity. Mezzanine financing typically is used to fund a growth opportunity, a new development, an acquisition or a new product development. Although it makes up a smaller percentage of total available project capital of a company, mezzanine financing has become critical to middle-market real estate development companies in recent years.

Mezzanine financing has been around for more than two decades. In the 1980's, the real estate financing business was dominated by insurance companies and savings and loan associations. By the 1990's, limited partnerships (LPs) had entered the arena. Today, investors in real estate development projects include pension funds, hedge funds, leveraged public finds, limited partnerships, and insurance companies, as well as banks that have established stand-alone mezzanine efforts. There are now more mezzanine lenders than active senior lenders, as a result of industry consolidation and credit tightening. According to a Chicago-based investment bank, Lincoln Partners, 500 W. Madison St., Suite 3900, Chicago, Ill. 60661, there are approximately 113 mezzanine providers in the real estate financing market today.

The real estate mezzanine finance model expense is based on uncovered risk. Mezzanine finance for real estate development evolved from corporate uses of mezzanine finance, where anticipated returns were often scaled on exit strategies such as initial public offerings. These anticipated returns were way above the return for a typical real estate development project. Real estate mezzanine finance is characterized by high cost/inefficiencies. Particular aspects of real estate mezzanine finance include:
$600B in U.S. real estate development projects between $50M-$100M cost alone.
Mezzanine finance is only one real estate development finance product—not a solution.
Mezzanine lenders have become very conservative to meet standards associated with securitizing debt.
Mezzanine finance is very expensive, because mezzanine finance is based on perception of risk, not risk mitigation.
Complicated inter-creditor agreements.
High internal rate of returns demanded on “uncovered” basis.
High participation demanded.
Costly delays coordinating competing interests.

Thus, current viable financial processes in real estate development financial circles do not efficiently fill the gap between developer equity and senior debt. However, the availability of mezzanine finance does not support or secure senior debt, and thereby remains a real estate development finance component—not an integrated solution. As a result, the ability to source the finance required to fill the gap between developer equity and senior debt for projects in the $50M-$100M cost range has become increasingly difficult to achieve. Middle market real estate development mezzanine finance often comes at the highest price structure—often exceeding 30% internal rate of return.

In addition, traditional development risk assessment for real estate development has been a static affair, where a view of the risks is taken and then is dormant over the term of the real estate development. A typical development period is a period of time up to 3 years. The greatest risks associated with real estate development are inherent in the prior art real estate financing process, which is fragmented, dependent upon the coordination of competing interests, and generally not risk considered. Steps can be taken to mitigate some of these risks, such as retaining legal counsel to perform due diligence and secure proper authorizations to proceed; construction insurance; combinations of surety, developer guaranteed maximum price (GMP) contracts, developer guarantees, construction validation report, and catastrophic insurance; construction defects insurance; and business interruption insurance; however, any one of these or other risks can result in the project being interrupted during the process, an all too common occurrence.

Accordingly, what would be beneficial would be a real estate development financing process that provides lower costs than the costs associated with mezzanine financing. What also would be beneficial would be a real estate development financing process that provides a comprehensive financing solution. What also would be beneficial would be a real estate development financing process that further mitigates the risks of real estate development. What also would be beneficial would be a real estate development financing process that assures continued financing for project completion.

### SUMMARY OF THE INVENTION

A real estate development financing process in accordance with the principles of the present invention provides lower costs than the costs associated with current real estate development structures. A real estate development financing process in accordance with the principles of the present invention provides a comprehensive financing solution for real estate development. A real estate development financing process in accordance with the principles of the present invention further mitigates the risks of real estate development. A real estate development financing process in accordance with the principles of the present invention further helps assure continued financing for real estate project completion.

A real estate development financing process is provided. Initial financing is provided by a real estate developer through equity. The equity financing by the real estate developer is sufficient to provide overhead protection to an insurable portion of the real estate development costs. The equity from the real estate developer is combined with new debt. The new debt is sufficient to cover fees, premiums, and contingent capital. The equity from the real estate developer and the new debt is combined with senior debt. The senior debt is sufficient for the costs of the real estate development remaining after the equity from the developer and the new debt. At least a portion of the new debt or the senior debt or both are insured. In one embodiment, the new debt is collateralized with insurance. The new debt can take the form of an insurance product comprising a low cost debt instrument as a substitute for mezzanine financing in real estate development financing. In addition, a real estate development risk index can be provided.

### BRIEF DESCRIPTION OF THE DRAWINGS

FIG. 1 is a graphical representation of a real estate development financing process in accordance with the principles of the present invention.

FIG. 2 is one embodiment of a real estate development financing process in accordance with the principles of the present invention.

FIG. 3 is another embodiment of a real estate development financing process in accordance with the principles of the present invention.

FIG. 4 is a schematic representation of an example structure that can be used to implement a real estate development financing process in accordance with the principles of the present invention.

FIG. 5 is a schematic representation of contributions as a percentage of costs in accordance with the principles of the present invention.

FIG. 6 is a schematic representation of detail in the coverage of insurance in accordance with the principles of the present invention.

### DETAILED DESCRIPTION OF THE INVENTION

A better understanding of the economic value of insurance as efficient capital has lead to a new real estate development risk approach and capital efficiency concept in accordance with the present invention. A real estate development financing process in accordance with the principles of the present invention creates new efficiencies by utilizing insurance to mitigate risks attributable to investors in real estate development projects. A real estate development financing process in accordance with the principles of the present invention addresses the inefficiencies inherent in mezzanine finance for real estate development and saves cost to each project in which the real estate development financing process of the present invention is utilized. A real estate development financing process in accordance with the principles of the present invention enables the developer to proceed without interruption.

The present invention uses value creation and third party developer direct investment to shield the initial “insurable structure” of the real estate development project. In turn, the initial “insurable structure” takes the risk away from the subsequent insurable structure of the project in which the insurance market may be participating. A real estate development financing process in accordance with the principles of the present invention is directed to a practical one-stop financing solution for real estate developers with middle-market construction projects. While the present invention is not limited to such projects, when used herein the term middle-market generally refers to real estate development projects in the range of about $50M-$100M. The real estate development financing process in accordance with the principles of the present invention combines developer's equity, new debt providers in accordance with the present invention, senior debt such as for example bank loans, and insurance in accordance with the present invention. The risk of an investment in the present invention is substantially lower than those assumed by mezzanine lenders since the present invention is a program solution and not merely a financial component of a transaction.

Under a canopy of profit potential and third party investment, a key to success in real estate development is the delivery of the marketable assets—lien free delivery of the completed structure—and ultimately the successful sale of the product. Since the delivery of the real estate development financing process of the present invention is essential to a development program, the present invention can be provided as a comprehensive developer/contractor insurance package. The premium paid by the developer for a standardized construction financing package with respect to non-relevant risk coverage is not high when compared with the time lost tailoring a construction insurance package along the lines of a “minimum expense” approach. Also from a management standpoint, the present invention must be able to respond to all packaging at least as swiftly as the fragmented approach to provide value. The real estate development financing process of the present invention can be provided by a third party insurance company, since these insurance elements carry with them some long-term consequences.

New debt providers in accordance with the present invention and senior debt providers will have an insurance product in accordance with the present invention supporting the debt. The insurance product of the present invention can be provided by an insurance entity formed in accordance with the present invention and established insurance companies. In one embodiment, a majority of required direct funding for the insurance entity of the present invention is reserved for insurance capital and only at risk under the insurance issued on a project-by-project basis after initial operations commence.

A real estate development financing process in accordance with the present invention employs low cost debt instruments as a substitute for mezzanine financing and insurance capital which is deployed at a measured risk to shareholders and investors. In one embodiment, the low cost debt instruments can be notes. The low cost debt instruments can also be capital insured notes, premium to market for comparable-term investments.

The amount of equity from the developer is designed as a sufficient investment to serve as overhead protection to the insurable portions of the costs. New debt of the present invention provides gap financing in an amount sufficient to cover required fees and insurance premiums as well as contingent capital, most usually found within the senior debt. The new debt of the present invention is collateralized by insurance. The collateralized insurance of the present invention can take the form of the insurance company of the present invention assuming a first portion of this coverage. The insurance company of the present invention will provide insurance policies covering a limited “first position” of the insurable risk on each project. Thus, the insurance company of the present invention takes the first layer of the risk, including the contingent capital risk, which is applied to a project by agreement with the developer and at a substantially higher cost structure. The result is an effective attachment point for insurance only after losses have reached a given percentage of total project costs.

The senior debt makes up the remaining costs of the real estate development. The senior debt is likewise collateralized by insurance. The present invention provides insurance coverage for both the new debt providers of the present invention and senior debt providers in the form of a comprehensive development and construction insurance package. The contents of such a package can be standardized for certain types of projects and customized for other types of projects. The guiding principal will be to insure all relevant events to further support the completion of each development program, providing the full marketable value of the project.

The construction package of insurance that will be provided can be characterized as “all that can be insured” with traditional products available—other than financial risk. Since the insured's position is no greater than the construction loan plus their premiums, and then they are double covered by the insurance package, the risk position then will always be manageable percentage less of value—there is little in the way of risk, when you can dispose of the assets at manageable percentage less of value. The insurance package can be provided through an insurance broker/strategic partner. Insurance involvement in the real estate development financing process in accordance with the present invention enables insurance for the new debt providers and reduces frictional costs that surround the senior debt element of the financing process.

The senior debt meets standard limitations of major lending institutions within the benefits of an insured structure in accordance with the present invention, thus reducing the cost of the senior debt. Third party insurers can assume the remaining portion of the project by cost, predominantly the senior debt portion. The senior debt provides the financial wrap around the remaining of the transaction cost structure.

In addition, the typical approach to real estate development due-diligence is static and performed prior to the start of the project. Because the insurance company of the present invention takes the meaningful first layer of the risk of the project, in one embodiment the present invention monitors and manages development risk. In accordance with the present invention, a dynamic assessment of risks is provided. The due diligence process of the present invention provides a basis for risk assessment and a program of monitoring variances.

Initially, the phases of development are identified to understand what level of risk is in play. The largest risk of real estate development is not having the entire financing solution at the outset of the project. By providing an integrated solution, the real estate development financing process of the present invention addresses this risk. In addition, typical real estate development project risk can be categorized into several categories. These include pre-development risks; development risks including entitlements (validation) risk and architectural/engineering risk; construction risks including pre-construction risk and construction (performance) risk; marketing risk; and sales risks including sales velocity risk, after market risk, and closing risk.

Development risk can be most generally characterized with several inquiries. Can the cost of assets created within the “insurable structure” be redeemed though sales during the projected sales period—or via alternative disposition? When used herein, the term “insurable structure” means a percentage of cost, after the developer's investment and a percentage of value under the profit potential of the project, including the then developer's investment. In what way does an interruption to successful project conclusion erode value beyond recovery within the developer's investment structure? In what way does an interruption to successful project conclusion erode value beyond recovery within the cost/insurable structure? In what way may interruptions to the process be covered by insurance, contingent capital or alternative disposition? In what way can catastrophic events be covered in a manner that does not reduce ultimate value?

In addition, in accordance with the present invention a number of variances can be tracked relative a standardized valuation report. Unlike the determination of probabilities, which is to some degree subjective, the variance of returns can be estimated so long as sufficient data on past results, current results and returns are available.

The results from development activities can be measured against proforma results over time, with trigger points to provide a cure for acceptable deviations. The present invention monitors the performance trend—variance from the expected results. This is what creates a dynamic process. The variance in results/returns, in effect, sets the boundaries of uncertainty or the “riskiness” of a particular venture. This is a dynamic process and should be monitored at least quarterly to render an accurate picture relative to the risks assumed by the present invention and its partners. The fundamentals associated with a project proforma are confirmed through established construction, marketing, and sales reporting.

In accordance with the present invention, a real estate development risk index is provided. The real estate development risk index of the present invention identifies the appropriate factors inherent in the control of development risks. These risks are measured or ranked. Using a standard index or scoring methodology, an index can then be constructed.

The first step in constructing an index is to establish a base value. Next, points across the various risk exposures are allotted and a system of evaluating variance from base values is created. Some of these variances can be evaluated in-house, and some need third party validation to keep the reporting system objective across banking, equity investment, and insurance.

A total number of points are allotted to risk categories. These include economic risks; development risk exposures including development risks, valuation risks, credit risk, and construction viability; and marketing risks. In one embodiment, economic risks can be assigned 10% of the risk and the marketing risks can be assigned 15% of the risk—these are the risks before and after the efforts of the developer, to which the project developer is entrusted. Thus, in this embodiment development risks can be assigned 75% of the total real estate risk exposure to the insurer(s) of development risk.

The components of the development risk exposures can be further broken down into discrete risk measures. In one embodiment these can include as development risks industry trends (2.5%), the project report (15.0%), approval report (2.5%), sponsorship (2.5%), legal report (2.5%), after market risk (2.5%), and a stress test (2.5%). The valuation risks can include cost method (2.5%), market approach (5.0%), asset disposition (2.5%), and the real estate development financing process of present invention approach (5.0%). The credit risks can include the real estate development financing process of present invention (10.0%), the developer's equity (2.5%), and the financial review (2.5%). The construction viability risks can include construction plan (5.0%), appropriateness (2.5%), systems (2.5%), contractor history (2.5%), and contracts (2.5%).

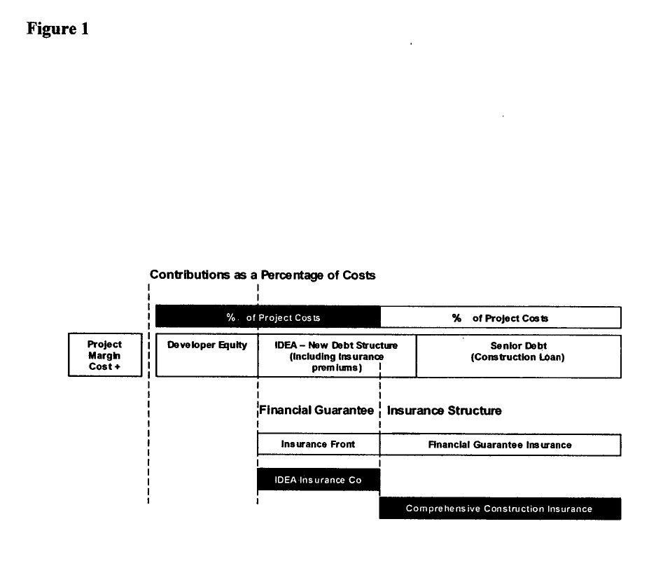

Referring to FIG. 1, a real estate development financing process in accordance with the principles of the present invention is depicted graphically. An amount of equity is designed as a sufficient investment to serve as overhead protection to the insurable portions of the costs. New debt of the present invention provides gap financing in an amount sufficient to cover required fees and insurance premiums as well as contingent capital. Traditionally, contingent capital/reserves are part of the senior debt offering. The senior debt makes up the remaining costs of the real estate development. Investors providing the first portion of the debt are indemnified, directly or indirectly, by an insurance company within the present invention while a second portion of the debt can be insured by a third party insurer.

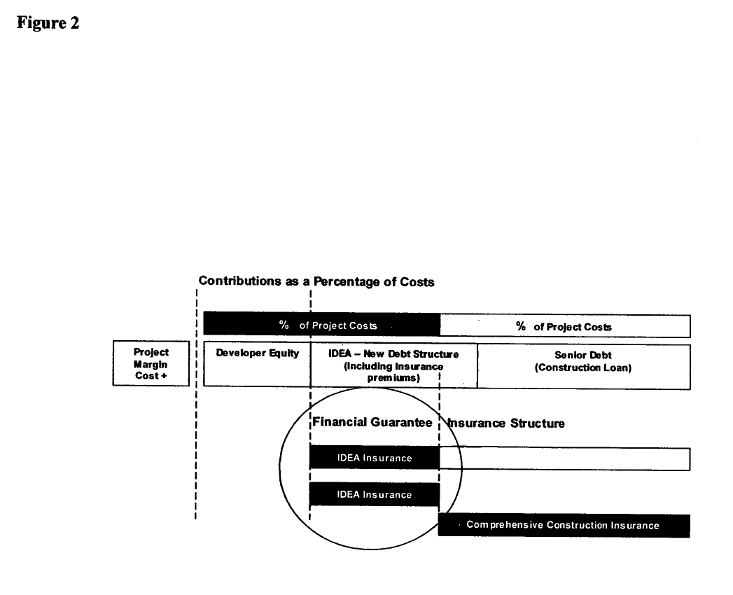

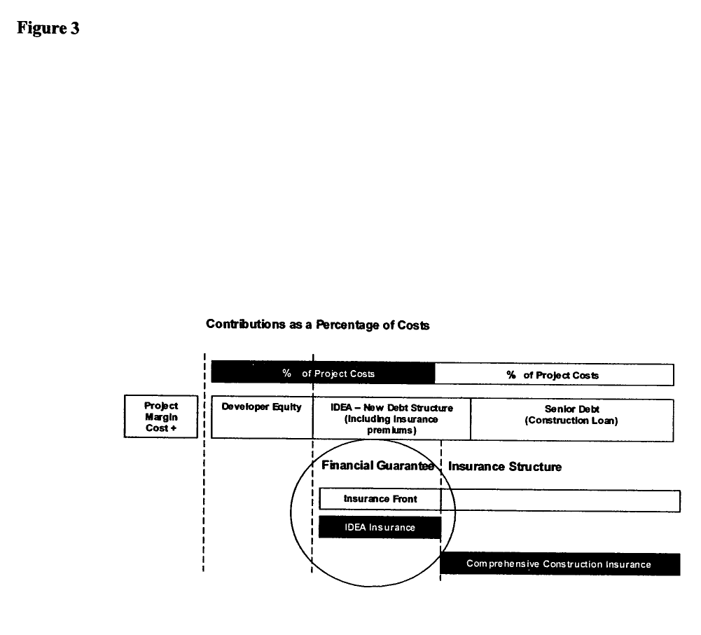

In one embodiment seen in FIG. 2, a single insurance company formed in accordance with the preset invention can provide the insurance for both the new debt providers of the present invention and senior debt providers. In another embodiment seen in FIG. 3, a fronting insurer and an insurance company formed in accordance with the present invention can provide the insurance, with each insurer having a risk of loss. The fronting insurer has credit risk the insurance company formed in accordance with the present invention will not pay. The insurance company formed in accordance with the present invention has the ultimate risk.

Since a clearly defined exit strategy is pivotal to the financing decision, the overall return on investment hinges on the ability of the developer to obtain the value of its equity position; that is, the developer must complete the development project for sale. The sale of the real estate development in the middle market occurs over a foreseeable timeline and the insurable structure of the present invention sits below the risk of loss of profit potential as well as the direct investment of the developer. In other words, the insurable structure of the present invention is only subject to loss after the profit potential in the project and the equity investment of the developer is exhausted.

A real estate development financing process in accordance with the principles of the present invention provides advantages to all of the participants. Each party to a transaction is only asked to do what they would/can do in the current market, with a wrap around provided for the whole transaction. The present invention directly takes up the risk that is currently a market gap—and realigns risk and reward in the notion of financial instruments—not positions.

The developer gets a “one-stop” solution. The developer can focus on the development and marketing program and not provide a large dedication to assembling finance components. To achieve the equity position, the developer can more easily attract investors to the model of the present invention due to the fact that there is a holistic/complete finance solution. The insurer sells a policy with comparable risk to a general contractor hired by a real estate developer at a much higher reward—with low transaction volume to produce such returns. The senior debt provider is offered a desirable range of costs with an insurance indemnity. The senior debt provider can easily roll-out debt of this quality and provide new capacity. Since the investment in front of the senior debt provider comes at a lower rolling cost—overall risk is reduced.

The general contractor on a project can provide the most efficient contract, knowing that the funds are in place for him to proceed. General contractors expend a lot of energy on projects that get tied up in costly finance delays. Speculative contract work is often lost. Project investors get leveragability of a capital insured, premium-to-market financial product, which nonetheless serves to provide inexpensive capital to the real estate developer. Any party that participates in the project has a far superior chance of receiving upside potential because much of the financial risk has been taken out of the financing process by the process of the present invention.

The following are non-limiting examples demonstrating implementation of funds in accordance with the principles of the present invention.

### EXAMPLE 1

As previously mentioned, while the present invention is not limited to middle-market estate development projects, in one embodiment the following can be typical example project criteria:
Projects in $50M-$100M range.
Projects are not expected to exceed a 3-year term.
Projects will be entitled and ready for construction—no pre-development risk.
Defined exit strategy based upon confirmation of specific demand and expected sales of end product such as for example for sale product with strong sales potential, pre-lease commitments, supporting take-out financing, strong alternative disposition potential, etc.

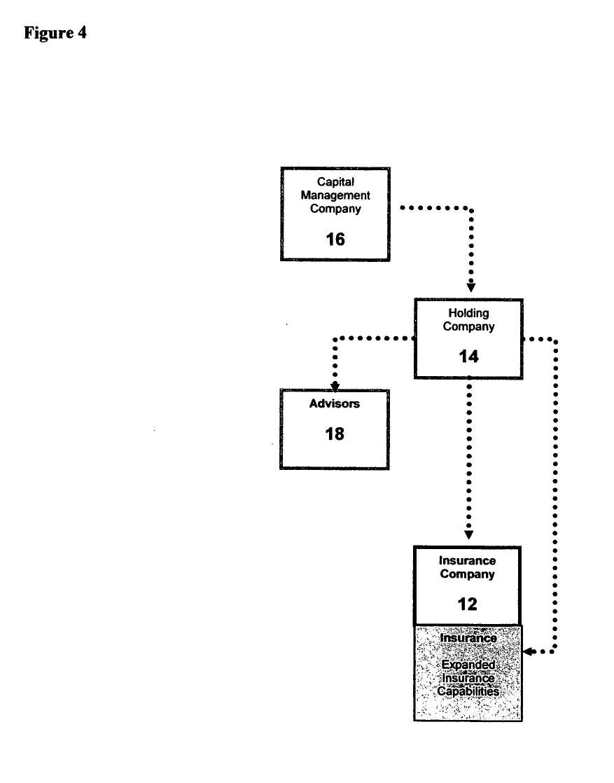

Referring to FIG. 4, a schematic representation of an example structure that can be used to implement a real estate development financing process in accordance with the principles of the present invention is seen. The insurance company can be a Bermuda Class 3 organization 12 organized under a holding company 14. A capital management company 16 can be provided to sourcing alternative debt to apply to each development project. Advisors 18 can be provided.

A holding company to own a capital management company and an insurance company of the present invention. A first investors set will invest in the holding company; thereafter the holding company will use such funds to capitalize the insurance company of the present invention. A second investor set, a different set of investors, will invest in the capital management company; the second investors set will receive notes from the capital management company. The capital management company will provide funds directly and indirectly for the developers in exchange for notes.

In one example, an real estate development financing process in accordance with the present invention has been developed with financing arranged in the following proportions:
Developer's equity—15%.
New debt providers of the present invention—21%.
Bank loans/senior debt—64%.

Insurance is provided for both the new debt providers of the present invention and senior debt providers (85% of the project by cost). The insurance coverage can be provided by one insurer, directly or indirectly, assuming 15% of the risk, and a second insurer assuming the remaining 70% (after estimated premium consideration to insurance this 70% exposure is, in effect, reduced to 64%) of the project by cost, predominantly the senior debt portion. Thus, the insurance company of the present invention takes the first layer of the risk, including the contingent capital risk, which is applied to a project by agreement with the developer and at a substantially higher cost structure. The insurance company of the present invention can participate in providing a fully collateralized financing program by assuming the first 15% of the projects costs, including 6% contingent capital (not immediately at risk) of the insurable structure of each project and 70% of the costs of the project (100% of the projects costs less 15% assumed by the insurer of the present invention and less the developer's 15% contribution), can be insured with third party insurers assuming the remaining 70% of project costs. The costs assumed by third party insurers predominantly relate to the senior debt portion. The result is an acceptable attachment point for third party insurance companies at 70% of costs. Such an attachment point is within the ambit of third party insurance company's premium structure.

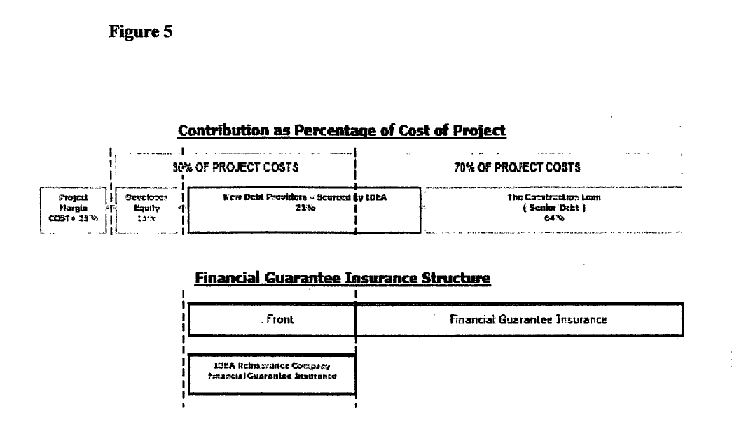

Referring to FIG. 5, a schematic representation of contributions as a percentage of costs in this example in accordance with the present invention is seen. The margin of profit on the project is assumed to be cost +20% or greater. Developer equity is 15%; the new debt structure in accordance with the present invention is 21%; while the senior debt (construction loan) is 64%. The first insurer provides an indemnity of the first 15% of the cost of the project over the developer equity. The remainder of the project costs is subject to insurance coverage.

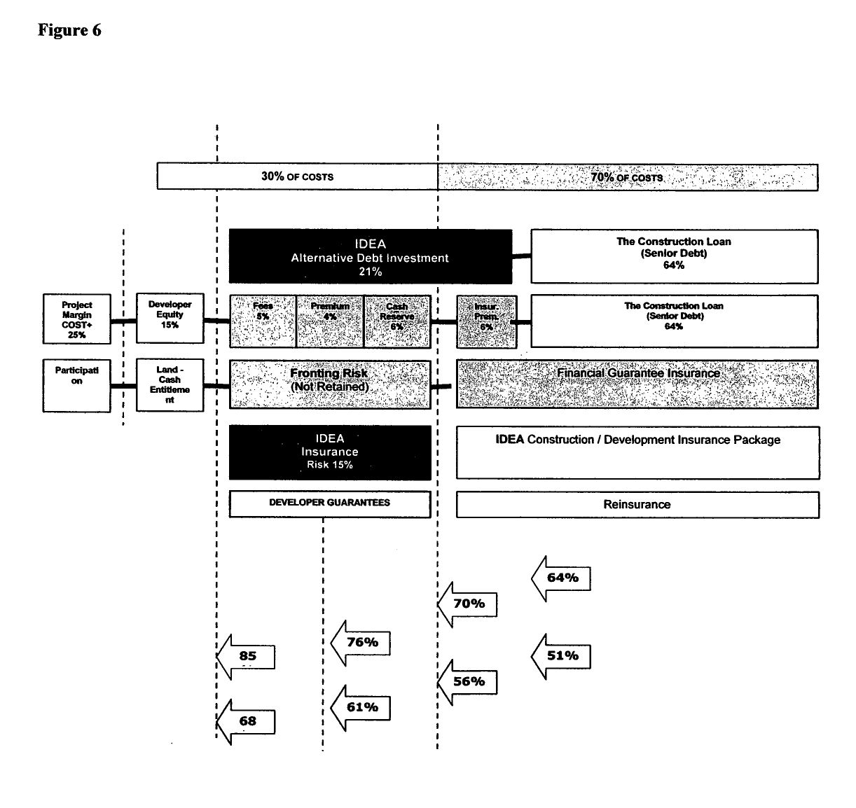

Referring to FIG. 6, a schematic representation of detail of the coverage of insurance in this example in accordance with the present invention is seen. The structure of the developer corresponding to the developer equity of 15% is depicted on the left; again, the margin of profit on the project is assumed to be cost +25% with developer equity at 15%. Again, the new debt structure in accordance with the present invention is 21%; while the senior debt (construction loan) is 64%. The first insurer provides an indemnity of the first 15% of cost of the project over the developer equity. The remainder of the project costs is subject to insurance. The lowermost arrows depict the risk as percentage of value while the arrows above depict risk as percentage of cost.

### EXAMPLE 2

The Appendix sets forth a spread-sheet of pro-forma financials for another example in accordance with the present invention comparing the financial results with a prior art mezzanine financing. Under both the present invention and mezzanine financing, the direct development costs are the same and assumed to be $42M, which includes land, architectural/engineering fees, entitlements, general development, construction, development fees, and advanced marketing. In the mezzanine financing, the sole cost of insurance is $800K for construction insurance. In the present invention, in addition to the $800K for construction insurance the costs of the insurance coverage and the insurance of the senior debt is $3M and the cost of legal fees is $100K. Thus, in this example the present invention carries a $3.1M increase in the cost of insurance.

The construction management ($200K) and completion reserve ($3.6M) of program costs for both the present invention and mezzanine financing is the same; however, the structuring fees of the present invention are $3M while the structuring fees of the mezzanine financing is $1.5M. In addition, the present invention includes $2.4M insurance fee and the cost of legal fees is $200K. Thus, in this example the present invention carries a $4.1 M increase in program costs.

In servicing the debt, the bank loan fees ($900K) for both the present invention and mezzanine financing are the same; however, the bank legal fees of the present invention are $150K while the bank legal fees of the mezzanine financing is $100K. For mezzanine financing, the interest for the bank loan is $5.6M while the interest on the non-bank loan is $7.5M; for the present invention, the interest for the bank loan is $3.6M while the interest on the non-bank loan is $2.1M. Thus, in this example the present invention carries a $7.350M decrease in debt service costs.

This example project generates $80M in sales, with marketing expenses ($3M), and equity ($9.3M) being the same for both the present invention and mezzanine financing. The mezzanine senior debt is $41.6M while the present invention senior debt is $39.65M. Surprisingly, the net for mezzanine financing is $16.9M while the net for the present invention is $20.15M. With the mezzanine financier having a 50% position, the net to the developer is $5.4M for mezzanine financing. Again, surprisingly, a position of just 25% in the present invention yields a $4.1875M fee while the net to the developer is $12.562M in the present invention.

While the invention has been described with specific embodiments, other alternatives, modifications and variations will be apparent to those skilled in the art. Accordingly, it will be intended to include all such alternatives, modifications and variations set forth within the spirit and scope of the appended claims.

Appendix
IDEA - Comparison to Mezzanine Finance
Based on Average Project Model (Above) $60 M Cost Structure

| | Mezzanine Model | | | IDEA Model | | |
|---|---|---|---|---|---|---|
| DIRECT COSTS | | | | | | |
| Land | Developer | 5,500,000 | | Developer | 5,500,000 | |
| Architectural/Engineering | Developer | 1,800,000 | | Developer | 1,800,000 | |
| Entitlements | Developer | 800,000 | | Developer | 800,000 | |
| General Development | Developer | 1,200,000 | | Developer | 1,200,000 | |
| Construction | Bank | 30,000,000 | | Bank | 30,000,000 | |
| Development Fees | Bank | 1,200,000 | | Bank | 1,200,000 | |
| Advanced Marketing | Bank | 1,500,000 | | Bank | 1,500,000 | |
| TOTAL | | | 42,000,000 | | | 42,000,000 |
| INDIRECT COSTS | | | | | | |
| INSURANCE | | | | | | |
| Construction Insurance | Mezzanine | 800,000 | | IDEA | 800,000 | |
| Financial Guarantee | Mezzanine | 0 | | IDEA | 3,000,000 | |
| Insurance Legal | Mezzanine | 0 | | IDEA | 100,000 | |
| | | | 800,000 | | | 3,900,000 |
| IDEA vs. MEZZ Program | | | | | | |
| Costs | | | | | | |
| Structuring Fees | Mezzanine | 1,500,000 | | IDEA | 3,000,000 | |
| IDEA Reinsurance | Mezzanine | 0 | | IDEA | 2,400,000 | |
| Insurance Legal | Mezzanine | 0 | | IDEA | 200,000 | |
| Construction Management | Mezzanine | 200,000 | | IDEA | 200,000 | |
| Completion Reserve | Mezzanine | 3,600,000 | | IDEA | 3,600,000 | |
| | | | 5,300,000 | | | 9,400,000 |
| DEBT COSTS | | | | | | |
| Bank Loan Fees | | 900,000 | | | 900,000 | |
| Interest - Bank Loan | | 5,600,000 | | | 3,600,000 | |
| Interest Non-Bank | | 7,500,000 | | | 2,100,000 | |
| Bank Legal Fees | | 100,000 | | | 150,000 | |
| | | | 14,100,000 | | | 6,750,000 |
| SALES | | 80,000,000 | | | 80,000,000 | |
| Balance Marketing | | 3,000,000 | | | 3,000,000 | |
| Mezzanine Costs | | 9,200,000 | | | 0 | |
| IDEA Costs | | 0 | | | 7,900,000 | |
| Senior Debt | | 41,600,000 | | | 39,650,000 | |
| Equity | | 9,300,000 | | | 9,300,000 | |
| NET | | | 16,900,000 | | | 20,150,000 |
| MEZZ Participation 50% | | 8,450,000 | | | 0 | |
| IDEA Participation 25% | | 0 | | | 5,037,500 | |
| NET to DEVELOPER | | 8,450,000 | | | 15,112,500 | |
| ROE (2-Year) | | 45.4% | | | 81.3% | |

What is claimed is:

1. A real estate development financing process comprising:
providing financing from equity;
combining the equity with non-senior debt;
combining the equity and the non-senior debt with senior debt; and
insuring the non-senior debt.

2. The real estate development financing process of claim 1 further wherein the senior debt comprises bank loans.

3. The real estate development financing process of claim 1 further comprising insuring the senior debt.

4. The real estate development financing process of claim 1 further wherein the equity is invested by the real estate developer.

5. The real estate development financing process of claim 1 further wherein the amount of equity comprises a significant investment as overhead protection to the insurable portions of the costs.

6. The real estate real estate development financing process of claim 5 further wherein the amount of equity comprises about 15% of the cost of the real estate development.

7. The real estate development financing process of claim 1 further wherein the non-senior debt comprises gap financing in an amount sufficient to cover fees, insurance premiums and contingent capital.

8. The real estate development financing process of claim 7 further wherein the non-senior debt comprises about 21% of the cost of the real estate development.

9. The real estate development financing process of claim 1 further wherein the non-senior debt is collateralized with insurance.

10. The real estate development financing process of claim 9 further wherein the collateralized insurance comprises a fully capitalized insurance company assuming a first portion of the insurance coverage.

11. The real estate development financing process of claim 1 further wherein the senior debt comprises the costs of the real estate development remaining after the equity and the non-senior debt.

12 The real estate development financing process of claim 11 further wherein the senior debt comprises about 64% of the cost of the real estate development.

13. The real estate development financing process of claim 1 further comprising targeting real estate developments in the middle-market.

14. The real estate development financing process of claim 13 further comprising targeting real estate developments in the range of about $50M-$100M.

15. An insurance product comprising:
a debt instrument as a substitute for non-senior debt financing in real estate development financing, the debt instrument being insured.

16. The insurance product of claim 15 further wherein the debt instruments are collateralized with insurance.

17. The insurance product of claim 16 further wherein the collateralized insurance comprises a fully capitalized insurance company assuming a first portion of this insurance coverage.

18. The insurance product of claim 15 further wherein the debt instruments comprise notes.

19. The insurance product of claim 18 further wherein the debt instruments comprise capital insured notes, premium to market for comparable-term investments.

20. The insurance product of claim 15 further comprising combining debt instruments with financing from equity from a real estate developer.

21. The financial guarantee insurance product of claim 15 further wherein the insurance product targets real estate developments in the middle-market.

22. The insurance product of claim 21 further wherein the insurance product targets real estate developments in the range of about $50M-$100M.

23. A real estate development financing process comprising:
providing financing for real estate development with equity;
combining the equity with non-senior debt that is insured; and
combining the equity and non-senior debt that is insured with senior debt that is insured.

24. The real estate development financing process of claim 23 further wherein the senior debt comprises bank loans.

25. The real estate development financing process of claim 23 further wherein the equity is invested by the real estate developer.

26. The real estate development financing process of claim 23 further wherein the amount of equity comprises a significant investment as overhead protection to the insurable portions of the costs.

27. The real estate real estate development financing process of claim 26 further wherein the amount of equity comprises about 15% of the cost of the real estate development.

28. The real estate development financing process of claim 23 further wherein the non-senior debt comprises gap financing comprising an amount sufficient to cover fees, insurance premiums, and contingent capital.

29. The real estate development financing process of claim 28 further wherein the non-senior debt comprises about 21% of the cost of the real estate development.

30. The real estate development financing process of claim 23 further wherein the insurance comprises a capitalized insurance company assuming a first portion of this insurance coverage.

31. The real estate development financing process of claim 23 further wherein the senior debt comprises the costs of the real estate development remaining after the equity and the non-senior debt.

32. The real estate development financing process of claim 31 further wherein the senior debt comprises about 64% of the cost of the real estate development.

33. The real estate development financing process of claim 23 further comprising targeting real estate developments in the middle-market.

34. The real estate development financing process of claim 33 further comprising targeting real estate developments in the range of about $50M-$100M.

35. A real estate development financing process comprising:
providing financing from equity significant to provide overhead protection to an insurable portions of the costs;
combining equity with non-senior financing in an amount sufficient to cover fees, insurance premiums and contingent capital;
combining equity and non-senior financing with senior debt sufficient for the costs of the real estate development remaining after the equity and the non-senior financing; and
insuring at least a portion of the insurable portions of the non-senior financing or the senior debt or both.

36. The real estate development financing process of claim 35 further wherein the senior debt comprises bank loans.

37. The real estate development financing process of claim 35 further wherein the equity is invested by the real estate developer.

38. The real estate development financing process of claim 35 further wherein the amount of equity comprises about 15% of the cost of the real estate development.

39. The real estate development financing process of claim 35 further wherein the gap financing comprises about 21% of the cost of the real estate development.

40. The real estate development financing process of claim 35 further wherein the non-senior debt is collateralized with insurance.

41. The real estate development financing process of claim 40 further wherein the collateralized insurance comprises a fully capitalized insurance company assuming a first portion of this insurance coverage.

42. The real estate development financing process of claim 35 further wherein the senior debt comprises about 64% of the cost of the real estate development.

43. The real estate development financing process of claim 35 further comprising targeting real estate developments in the middle-market.

44. The real estate development financing process of claim 43 further comprising targeting real estate developments in the range of about $50M-$100M.

45. A financial product comprising a capital insured note for investment in real estate development financing.

46. The financial product of claim 45 further wherein the capital insured note is a substitute for non-senior debt financing in real estate development financing.

47. The financial product of claim 45 further comprising combining the capital insured note with financing from equity from a real estate developer.

48. The financial product of claim 45 further wherein the capital insured note targets real estate developments in the middle-market.

49. The financial product of claim 48 further wherein the capital insured note targets real estate developments in the range of about $50M-$100M.

50. A real estate development risk index comprising identified risk factors that control development risk, the identified risk factors being measured against proforma results over time, and variances from the expected result quantified into a scoring methodology.

51. The real estate development risk index of claim 50 further comprising the risk factors being identified as selected from the group comprising pre-development risks, development risks, construction risks, marketing risk, sales risks, and combinations thereof.

52. The real estate development risk index of claim 50 further comprising the risk factors being identified as selected from the group comprising pre-development risks, entitlements (validation) risk, architectural/engineering risk, preconstruction risk, construction (performance) risk, marketing risk, sales velocity risk, after market risk, closing risk, and combinations thereof.

53. The real estate development risk index of claim 50 further comprising identified risk factors being measured against factors selected from the group comprising industry trends, project report, approval report, sponsorship, legal report, after market risk, stress test, cost method, market approach, asset disposition, real estate development financing, equity, the financial review, construction plan, appropriateness, systems, contractor history, contracts, and combinations thereof.
